(19) United States
(12) Patent Application Publication
(10) Pub. No.: US 2021/0141764 A1
(43) Pub. Date: May 13, 2021

(54) METADATA VERIFICATION IN A DISTRIBUTED STORAGE SYSTEM

(71) Applicant: Western Digital Technologies, Inc., San Jose, CA (US)

(72) Inventor: Bruno Keymolen, Ghent (BE)

(21) Appl. No.: 16/681,837

(22) Filed: Nov. 13, 2019

(51) Int. Cl. G06F 16/16; G06F 16/182; G06F 16/13; G06F 9/30

(52) U.S. Cl. CPC G06F 16/164; G06F 16/182; G06F 9/30029; G06F 16/162; G06F 16/134

(57) ABSTRACT

An example method may determine if a storage area is an active storage area based on values stored therein. A metadata index is requested from non-volatile storage in a distributed storage system and includes a metadata-stored lane identifier uniquely configured to identify a lane in a storage area of the distributed storage system, and a metadata-stored random number unique to the lane. A lane-stored lane header in the storage area is pointed to by the metadata-stored lane identifier and includes a lane-stored lane identifier, a lane-stored random number, and a lane-stored lane magic value. A metadata-generated lane magic value is generated based on the metadata-stored lane identifier, and the metadata-stored random number in the metadata index. The lane in the storage area of the distributed storage system is identified as an active lane when the metadata-generated lane magic value matches the lane-stored lane magic value.

### TECHNICAL FIELD

The present disclosure generally relates to data storage, and in a more particular example, to the management of metadata in data storage systems.

### BACKGROUND

The performance of large-scale distributed storage systems to efficiently handle read and write operations in a scalable way depends on the efficient handling of an index which may be susceptible to errors during transient operating conditions. For example, indexes, such as metadata indexes, may be used to identify and access data objects stored in a distributed storage system. Generally, a data object is stored in a storage area, such as a non-volatile storage area, and then a metadata index is updated to allow future access to the stored data object. However, if transient conditions occur, such as power failure or an unplanned power-down of the system prior to or during the updating of the metadata index, then on a subsequent power-up of the system, the metadata index often does not accurately reflect the state of the stored data object.

Various attempted approaches have resulted in various drawbacks including loss of efficiency and responsiveness in attempting to recreate an accurate metadata index. When scaled within a distributed storage system, these problems become particularly exacerbated.

In addition to addressing the storage of indexes, any solutions to the management of such indexes should be aware of any overhead burden placed on the system to address the index correction. Accordingly, a solution is needed, for example, to verify and correct indexes while helping to address the challenge of managing the breakneck speed of growth of data.

### SUMMARY

The present disclosure describes, among other things, various aspects for accommodating the verification and correction of a metadata index stored in non-volatile storage while still allowing all of the data objects stored in the non-volatile storage areas of a distributed storage system to be retrieved in a timely manner.

One general aspect includes a method, comprising requesting a metadata index from non-volatile storage in a distributed storage system, the metadata index includes a metadata-stored lane identifier uniquely configured to identify a lane in a storage area of the distributed storage system; and a metadata-stored random number unique to the lane. The method further comprises reading a lane-stored lane header in the storage area of the distributed storage system pointed to by the metadata-stored lane identifier, where the lane-stored lane header includes a lane-stored lane identifier, a lane-stored random number, and a lane-stored lane magic value. The method yet further comprises generating a metadata-generated lane magic value based on the metadata-stored lane identifier and the metadata-stored random number in the metadata index; and in response to the metadata-generated lane magic value matching the lane-stored lane magic value, identifying the lane in the storage area of the distributed storage system as an active lane in the distributed storage system.

Another general aspect includes a system comprising request processing module configured to: request a metadata index from non-volatile storage in a distributed storage system, the metadata index includes: a metadata-stored lane identifier uniquely configured to identify a lane in a storage area of the distributed storage system; and a metadata-stored random number unique to the lane. The system further comprises a metadata index processing module configured to: read a lane-stored lane header in the storage area of the distributed storage system pointed to by the metadata-stored lane identifier, where the lane-stored lane header includes: a lane-stored lane identifier; a lane-stored random number; and a lane-stored lane magic value; generate a metadata-generated lane magic value based on the metadata-stored lane identifier, and the metadata-stored random number in the metadata index; and in response to the metadata-generated lane magic value matching the lane-stored lane magic value, identify the lane in the storage area of the distributed storage system as an active lane in the distributed storage system.

Implementations may include one or more of the following features: generating the metadata-generated lane magic value includes exclusive OR-ing the metadata-stored lane identifier with the metadata-stored random number; in response to identifying the lane in the storage area as an active lane, reading a metadata first segment index number from the metadata index; reading a lane-stored first segment header, designated by the metadata first segment index number, of a first segment in the storage area of the active lane of the distributed storage system; that the lane-stored first segment header includes a lane-stored first segment magic value and a lane-stored first segment index number configured to uniquely identify the first segment; generating, in the metadata index, the metadata-stored random number and a metadata-generated first segment magic value based on the metadata first segment index number; in response to the metadata-generated first segment magic value matching the lane-stored first segment magic value, identifying the first segment in the storage area as an active storage first segment in the active lane of the distributed storage system; matching the lane-stored first segment magic value further comprises generating a sequentially-generated second segment index number that is sequentially next following the lane-stored first segment index number and reading a lane-stored second segment header, designated by the sequentially-generated second segment index number, of a second segment in the storage area of the active lane of the distributed storage system; that the lane-stored second segment header includes a lane-stored second segment magic value and a lane-stored second segment index number configured to uniquely identify the second segment; generating, in the metadata index, the metadata-stored random number and a sequentially-generated second segment magic value based on the sequentially-generated second segment index number; that matching the lane-stored first segment magic value further comprises, in response to the sequentially-generated second segment magic value matching the lane-stored second segment magic value, identifying the second segment in the storage area as a second active storage second segment in the active lane of the distributed storage system; that matching the lane-stored first segment magic value further comprises, in response to the sequentially-generated second segment index number being absent from the metadata index, writing the sequentially-generated second segment index number to the metadata index; that the first segment further comprises a first footer that includes a first footer segment magic value configured to match the lane-stored lane magic value; in response to identifying the lane in the storage area as an active lane, reading a lane-stored first segment header of a first segment in the storage area of the active lane of the distributed storage system; that the lane-stored first segment header includes a lane-stored first segment magic value and a lane-stored first segment index number configured to uniquely identify the first segment; generating a lane-generated first segment magic value based on the lane-stored first segment index number and the lane-stored random number in the lane-stored lane header; in response to the lane-generated first segment magic value not matching the lane-stored first segment magic value, identifying the first segment in the storage area as an available storage first segment in the active lane of the distributed storage system; changing the lane-stored random number to effectively erase the storage area of the lane in the distributed storage system; that the requesting the metadata index further comprises retrieving a non-volatilely stored metadata index from the non-volatile storage and generating the metadata index in volatile storage.

Implementations may include one or more of the following features. The system where to generate the metadata-generated lane magic value includes to exclusive OR the metadata-stored lane identifier with the metadata-stored random number. The system where the metadata index processing module is further configured to: in response to identifying the lane in the storage area as an active lane: read a lane-stored first segment header, designated by a metadata-stored first segment index number, of a first segment in the storage area of the active lane of the distributed storage system, where the lane-stored first segment header includes a lane-stored first segment magic value and a lane-stored first segment index number configured to uniquely identify the first segment; generate, in the metadata index, a metadata-generated first segment magic value based on the metadata-stored first segment index number and the metadata-stored random number; in response to the metadata-generated first segment magic value matching the lane-stored first segment magic value, identify the first segment in the storage area as an active storage first segment in the active lane of the distributed storage system; that the metadata index processing module is further configured to, in response to the sequentially-generated second segment magic value matching the lane-stored second segment magic value, identify the second segment in the storage area as a second active storage second segment in the active lane of the distributed storage system; that the metadata index processing module is further configured to, in response to the sequentially-generated second segment index number being absent from the metadata index, write the sequentially-generated second segment index number to the metadata index; that the metadata index processing module is further configured to, in response to identifying the lane in the storage area as an active lane, read a lane-stored first segment header of a first segment in the storage area of the active lane of the distributed storage system, where the lane-stored first segment header includes a lane-stored first segment magic value and a lane-stored first segment index number configured to uniquely identify the first segment; that the metadata index processing module is further configured to generate a lane-generated first segment magic value based on the lane-stored first segment index number and the lane-stored random number in the lane-stored lane header; that that the metadata index processing module is further configured to, in response to the lane-generated first segment magic value not matching the lane-stored first segment magic value, identify the first segment in the storage area as an available storage first segment in the active lane of the distributed storage system; and that the metadata index processing module is further configured to change the lane-stored random number to effectively erase the storage area of the lane in the distributed storage system.

A further general aspect includes a system comprising: means for requesting a metadata index from non-volatile storage in a distributed storage system, the metadata index includes a metadata-stored lane identifier uniquely configured to identify a lane in a storage area of the distributed storage system, and a metadata-stored random number unique to the lane; means for reading a lane-stored lane header in the storage area of the distributed storage system pointed to by the metadata-stored lane identifier, where the lane-stored lane header includes a lane-stored lane identifier, a lane-stored random number, and a lane-stored lane magic value; means for generating a metadata-generated lane magic value based on the metadata-stored lane identifier, and the metadata-stored random number in the metadata index; and in response to the metadata-generated lane magic value matching the lane-stored lane magic value, means for identifying the lane in the storage area of the distributed storage system as an active lane in the distributed storage system.

The disclosure herein provides various advantages and benefits. Many devices may be configured in storage groups or blocks based on specific architectures. For example, non-volatile storage devices may be architected to include erasure blocks which should preferably be considered when storing data. For example, in some instances, storage devices may utilize write-limited technology that may only reliably be overwritten for a fixed number of times. Identifying the end of previously written valid data in the storage devices may facilitate append-only writing to the next-available storage locations which maintains a consistent quantity of writes across the media. Further, erasures of the data may be accomplished by modifying a limited number of storage locations. Accordingly, lanes, as described herein, may be arranged to be respectful of various storage architectures. Further, various non-volatile storage devices may be implemented using various technologies that exhibit intrinsic characteristics. For example, some non-volatile storage technologies are capable of a limited number of reliable rewrite cycles for each of the storage cells before the performance of the storage cells degrades. Accordingly, the techniques described herein provide a technique for verifying and correcting metadata indexes as well as identifying actual stored data objects in the presence of random stored values that are remnants of deleted data objects. Further, the techniques described herein provide for an identification of a next-available write location in an append-only storage system.

It should be understood, however, that the above list of features is not all-inclusive and many additional features and advantages, such as but not limited to those discussed below, are contemplated and fall within the scope of the present disclosure. Moreover, it should be understood that the language used in the present disclosure has been principally selected for readability and instructional purposes, and not to limit the scope of the subject matter disclosed herein.

### BRIEF DESCRIPTION OF THE DRAWINGS

FIG. 1 illustrates example storage and retrieval of data in a distributed storage system.

FIG. 2 illustrates an example partitioning of non-volatile storage into various lanes.

FIG. 3 illustrates an example interaction between a client and a distributed storage system.

FIG. 4 illustrates the structure of an example disk metadata index.

FIG. 5 illustrates an example disk metadata index having undergone a reduction in segment index numbers.

FIG. 6 illustrates an example for locating a data object corresponding to a segment index number that has been deleted from the metadata index.

FIG. 7 illustrates an example for verifying a metadata index and locating valid lane and valid segments in a distributed storage system.

FIG. 8 illustrates an example method for identifying valid lane and segments in a distributed storage system.

FIG. 9 illustrates an example system configured to identify valid lane and segments in a distributed storage system.

### DETAILED DESCRIPTION

Often, distributed storage systems (DSSs) are used to store large amounts (i.e., terabytes, petabytes, exabytes, etc.) of data, such as objects or files in a distributed and fault-tolerant manner with a predetermined level of redundancy.

Some existing object storage systems store data objects referenced by an object identifier versus file systems. This can generally allow object storage systems to surpass the various imposed limits (e.g., actual or arbitrary maximum limits, thresholds, etc.) for storage capacity of file systems in a flexible way such that, for example, storage capacity is added or removed as a function of the applications, systems, and/or enterprise needs, while reducing degradation in performance as the system grows. As a result, object storage systems are often selected for large-scale storage systems.

In the storage of data objects, object identifiers may be generated and may be associated with an index number and together stored in a metadata index. In order to solve the problem of management of the metadata index, there is made use of stored magic values which provides for verification of stored data objects to verify the metadata index and rebuild the index where necessary. Magic values are specific values or data patterns that may be generated from a known random number that is mathematically combined with another known value. The resulting “magic value” is a purposefully generated value that is distinguishable from other present data.

The concept is developed for storage nodes making use of storage devices based on Flash, Shingled Magnetic Recording (SMR), or Perpendicular Magnetic Recording (PMR).

One solution is to cache or store the metadata index in RAM, but such an approach is not feasible in such large-scale storage systems as the size of the metadata index could grow to excessive sizes (e.g., in an example system, it could grow to over 25 terabytes (TB), which can no longer be handled in random access memory (RAM) in that example system, although numerous other constraint variations apply).

FIG. 1 illustrates the storage and retrieval of a set of data (also referred to as a “chunk” or merely “data” or “data object”) in a distributed storage system (DSS). A data storage process illustrated with respect to system 100 occurs between a client device 106 and a distributed storage system 110. In a distributed storage system, a PUT or write request operation 112 sends data object 116 to the distributed storage system 110 for storage. The distributed storage system 110 returns an object identifier (ID) 118 in a response operation 113. Similarly, in a GET or read request operation 114, client device 106 sends the object identifier (ID) 118 to the distributed storage system 110. In a response operation 115, the distributed storage system 110 returns, to the client device 106, the data object 116 that was previously stored therein.

The distributed storage system 110 further includes a metadata index 134 configured to map an object identifier (ID) 118 to physical storage. As discussed above, as more data objects 116 are stored in the distributed storage system 110, the metadata index 134 will continue to grow as physical storage mapping associated with object IDs continues to grow. The updating of the metadata index may occur after data objects have been written to the distributed storage system. However, transient conditions may occur after the data object is stored in the distributed storage system, but before the metadata index is updated to reflect the storing of the data object leading to an inaccurate metadata index when the transient condition ceases.

FIG. 2 illustrates a physical layout of non-volatile storage in the distributed storage system. Non-volatile storage (e.g., disk) 111 may be laid out according to a physical layout 206. The physical layout 206 may include one or more lanes 210 for storing the data objects 116. While one lane may be sufficient, the embodiment illustrated in FIG. 2 includes a plurality of lanes, namely three lanes 210.1, 210.2, and 210.3 (also simply referred to as 210). Each of the lanes 210 includes a lane header 215 identifying the lane and a payload or storage area (e.g., 220.1, 220.2, 220.3, 220.4, etc.) (also referred to as simply 220). The lane header stored in a lane of non-volatile storage may also be distinguished as a lane-stored lane header 215. The lane header may also include a lane identifier and random number as further described herein. Furthermore, data objects 116 may be sequentially stored in the storage area 220 using an append-only configuration.

The layout 206 of the non-volatile storage 111 may coincide with the underlying storage architecture which may coincide with the multiple erase blocks or Shingled Magnetic Recording (SMR) zones in various storage media that include parallel or concentric architectures. The non-volatile storage 111 may further include a separate lane or storage area 220.4 which may also include a header 227 and may be used to non-volatilely store a copy of the metadata index 134, the reduction of which is further described herein.

The non-volatile storage 111 may include a header 227 and a storage area 220.4 were the portion of the metadata index 130 may be stored. The portion of the metadata index 134 that becomes the reduced metadata index 154 may also be referred to as an anchor log.

As stated, a copy of the disk metadata index (also known as the “anchor log”) 154 may store at least a portion of the metadata index 134. The metadata index 134 provides an index identifying storage locations within the non-volatile storage 111 when partitioned according to the layout 206.

FIG. 3 illustrates a more detailed diagram of system 100. As stated, the client device 106 interacts with the distributed storage system 110. The interaction may occur when a client device 106 issues a write request operation 112 includes a data object 116. The distributed storage system 110 receives the write request includes the data object and determines where to store the data object 116 in non-volatile storage 111. The distributed storage system 110 creates and manages a metadata index 134 which provides an index for accessing the data objects 116 stored in non-volatile storage 111.

As described above and as illustrated in FIG. 3, the non-volatile storage 111 is configured according to a layout 206 which may include a plurality of lanes 210 in which a data object 116 may be stored. The location of the storage of data object 116 is maintained by metadata index 134. The metadata index 134 maintains a mapping of lane identifiers (IDs) 122 for each of the corresponding physical lanes 210 in non-volatile storage 111. The metadata index 134 further includes a segment index number 124 which corresponds to the sequentially incrementing segments in each of the lanes 210. Further, the metadata index 134 associates an offset in the lane 126 with each segment index number 124. The offset in the lane 126 corresponds to a physical memory address within the lane 210 where the data object 116 is physically stored. As illustrated in FIG. 3, metadata index 134 illustrates a plurality of lanes 210 identified according to lane identifiers (IDs) 122.1-122.L.

As stated, each of the plurality of lanes may be configured to store a plurality of segments (e.g., “chunks”). For example, a lane 210.1 may include increasing segment index numbers, an example of which may be index_1, index_2, index_8, and index_11. Similarly, lane 210.2 may include increasing segment index numbers, an example of which may be index_2, index_3, and index_5. Each segment may be associated with an increasing segment index number. A segment index number identifies the position of the segment in the lane. In some cases, the segment index number is unrelated to the actual disc offset. Further, segment index numbers may show gaps after deletion, and different lanes may have the same segment index numbers repeated for that lane.

FIG. 4 illustrates further detail of the metadata index 134. For each of the corresponding lanes in the non-volatile storage 111, the metadata index 134 includes a respective index. For example, lane_1 210.1 of FIGS. 2 and 3 includes a corresponding metadata index entry 402.1. Metadata index entry 402.1 includes a lane identifier (ID) 122.1, a random number 123.1, segment index number 124, and offset or offset in the lane 126. The lane identifier (ID) 122 corresponds to one of the plurality of lanes 210 and the segment index number 124 corresponds to an index number of a storage segment distributed along storage area 220. The random number 123.1 is a unique random number for each lane. Because the data is appended along each of the storage areas 220, each appended segment is identified by an increasing segment index number 124. The segment index number 124 identifies the position of the data object in the storage area 220 of the lane 210, but the segment index number 124 is not related to the actual disc offset in the storage area 220. Instead, the offset or offset in the lane 126 provides a physical offset from the beginning of the lane to the actual segment of the lane that includes the specific data object.

FIG. 5 illustrates a yet further detailed architecture for management of the metadata index 134 described herein. In order to accommodate recovery from a device on power-up, the metadata index 134 may be copied and stored in non-volatile storage 111 as a copy of the metadata index.

As stated above, the various embodiments manage the voluminous metadata index. By way of example, FIG. 5 illustrates three separate indexes. Index 510 illustrates a populated metadata index. That is to say, index 510 contains a segment index number 124 and offset 126 pair for each data object stored in the non-volatile storage 111. As further described above, storage of such a fully populated index becomes impractical as the size of the metadata index may consume the available non-volatile memory. Accordingly, the various aspects described herein reduce or prune a fully populated metadata index down to a manageable size. The pruning or reduction occurs when the size of the metadata index exceeds an excessive metadata index size threshold 570. The threshold 570 may be managed according to various factors include the available non-volatile resources in the specific system that may be allocated for storing the metadata index.

The index 520 illustrates a reduced (pruned) metadata index, illustrated as reduced metadata index 534. Generation of reduced metadata index 534 is accomplished by performing a pruning or reduction algorithm on index 510. The pruning algorithm may include the deletion of certain ones of the segment index number and offset pairs. By way of example and not limitation, some of the pairs may be deleted based upon their even or odd index numbering. Further, others of the pairs may be deleted based upon other factors such as deletion of all but every third, fourth, etc. pair. Yet further, other factors for selecting ones of the pairs to delete may include the length of the offsets or other factors.

By way of example, FIG. 5 illustrates the pruning of three of every four pairs within the fully populated metadata index 510. Accordingly, the remaining segment index number and offset pairs include, for example, segment 124.1 and offset 126.1, segment 124.5 and offset 126.5, segment 124.9 and offset 126.9, and segment 124.13 and offset 126.13 are retained, as illustrated in index 520. Accordingly, after the pruning of the metadata index, not all pairs remain represented in the reduced metadata index 534 and a reduction of 75% in the size of the metadata index may be obtained. The reduced (pruned) index 520 may then become the reduced metadata index 534 with the remaining metadata index pairs therein being known, for example, as “anchors” listed in the reduced metadata index 534.

As the reduced metadata index 534 increases in size, the excessive metadata index size threshold 570 may be applied to the reduced metadata index 534 to engage in continuous pruning of the metadata index.

FIG. 5 also illustrates the non-volatile storage of the reduced metadata index 534 as a copy 530 of the reduced metadata index 554 stored in non-volatile storage 111. As stated above, non-volatile storage of the reduced metadata index enables recovery during volatile memory loss such as during startup or power interrupt conditions.

FIG. 6 is a diagram illustrating addressing of a specific data object utilizing a reduced metadata index. By way of example, a lane 210.1 includes a lane header 215 and a storage area 220.1. The storage area 220.1 may include segments 610.1, 610.2, 610.3, and 610.4 (also referred to as simply 610). Each of the segments 610 includes a segment header (e.g., 625.1, 625.2, 625.3, 625.4, etc., also referred to as simply 625) and a data object (e.g., 640.1, 640.2, 640.3, 640.4, etc., also referred to as simply 640). Further, segment header 625 includes a segment index number (e.g., 629.1, 629.2, 629.3, 629.4, etc., also referred to as simply 629) and a segment length (e.g., 633.1, 633.2, 633.3, 633.4, etc., also referred to as simply 633).

Also illustrated in FIG. 6 is a linked list 645 comprised of a first link 650.1, a second link 650.2, and third link 650.3 (also referred to as simply 650). The linked list 645 and links 650 are illustrative and are formed by each of the segment length 633. The size of the linked list and the number of links is purely illustrative and will vary upon the extent of the pruning that occurred to generate the reduced metadata index 534.

Reduced metadata index 534 includes a lane identifier (ID) 122 which includes a segment index number 124 and an offset in the lane 126. Reduced metadata index 534 corresponds to the reduced metadata index 534 of FIG. 5 where one out of four indexes 510 were retained in the reduced metadata index 534.

In operation, the distributed storage system 110 receives a read request operation 114 including an object identifier (ID) 118 from a client device 106. The distributed storage system 110 then processes the index 510 including the segment index number 124 offset 126 to determine a location of the requested data object. By way of example, if the requested data object is data object 640.1, and the index 510 is directly resident in the reduced metadata index 534 as segment 124.1 and offset 126.1, then, by knowing the segment and the offset with respect to a beginning of the lane 210.1, the first data object 640.1 is directly addressable and therefore directly retrievable from the information remaining in the reduced metadata index 534.

If the index 510 received from the client device 106 is for the fourth data object 640.4, then the distributed storage system processes the index 510 and looks for the corresponding segment index_4 in the reduced metadata index 534. However, because the segment index number_4 for segment_4 was deleted in a previous metadata index reduction process, the distributed storage system looks for the next lower segment index number resident in the reduced metadata index 534. The next lowest segment index number resident in the reduced metadata index 534 is the segment index number_1 124.1 corresponding to segment index_1. Accordingly, the distributed storage system uses the index for segment_1 to identify a physical addressable location in storage area 220.1 and then compares the segment index number therein for a match with the requested segment index number. Accordingly, the requested segment index number does not match the resident segment index number in the request received from the client device. Accordingly, the distributed storage system identifies the segment length_1 633.1 associated with the segment index number 629.1 and uses the segment length 633.1 as a link 650.1 to ‘jump’ to the next segment without having to sequentially traverse the length of the first data object 640.1 in search of an end of object indicator.

Thereafter, when the addressing is linked to the second segment 610.2 by link 650.1, the distributed storage system compares the segment index number 629.2 with the segment index number received in the request and determines that there is still not a match in the segment index numbers. Accordingly, the distributed storage system repeats the process by using the segment length 633.2 as a link 650.2 to ‘jump’ past the second data object 640.2 and arrive at the third segment 610.3. The process then compares the segment index number 629.3 with the segment index number received in the request and again determines that the segment index numbers do not match.

Yet again, the distributed storage system repeats the process by using the segment length 633.3 as a link 650.3 to ‘jump’ past the third data object 640.3 and arrive at the fourth segment 610.4. The process then compares the segment index number 629.4 with the segment index number received in the request and determines that the segment index numbers do match. The process then retrieves the requested fourth data object 640.4 from the storage area 220.1 of the non-volatile storage 111 and returns the fourth data object 640.4 in the receive operation 115 in response to the read request operation 114.

It should be noted that the retrieval of data objects, as described above, that do not include indexes in the reduced metadata index 534, require minimal additional steps to identify and retrieve the data objects since the segments in the lane may be traversed as a linked list 645 without requiring a sequential read of each of the bits of the intervening segments.

FIG. 7 is a diagram illustrating verification and correction of a metadata index based on traversal of a lane of object storage in a distributed storage system. By way of example, a lane 710.1 includes a lane header 715.1 and a storage area 720.1. The storage area 720.1 may include segments 710.1, 710.2, 710.3, and 710.4 (also referred to as simply 710). Each of the segments 710.1, 710.2, and 710.3 includes respective segment headers 725.1, 725.2, and 725.3 and respective data objects 740.1, 740.2, and 740.3. Further, segment headers 725.1, 725.2, and 725.3 include respective segment index number 729.1, 729.2, and 729.3 and respective segment lengths 733.1, 733.2, and 733.3.

The lane-stored lane header 715.1 also includes a lane-stored lane magic value 714. A “magic value” is a unique number that is the result of a specific operation that uses other characteristics to create the unique number. The magic value is sufficiently unique that it is able to be reliably distinguished from random values that provide validation that the present data is valid data as opposed to remnants of erased data. By way of example, the lane-stored lane magic 714 may be a product of performing the mathematical operation of exclusive-OR-ing of the lane-stored lane identifier 722 with the lane-stored random number 723.

It is noted that additional verifications and validations may be performed on additional tiers, such as on disks or volumes. For example but not shown, a disk may include a disk-stored disk header including a disk identifier 120 (see FIG. 3), a random number, and a disk-stored disk magic value. The operations of such further use of stored identifiers, random numbers, and magic values could be implemented according to the processes described herein.

FIG. 7 further illustrates a metadata index 734 which may be either a full metadata index, like index 510 or a reduced metadata index like index 520 described above with respect to FIG. 5. Metadata index 734 was previously stored in non-volatile storage to enable recovery and startup following a transient condition such as power failure or an unexpected power-off condition. Metadata index 734 includes a lane identifier (ID) 122 which includes a segment index number 124 and an offset in the lane 126.

In operation when recovering from a transient condition, the distributed storage system 110 requests the metadata index 734 from non-volatile storage in the distributed storage system. The metadata index 734 includes a metadata-stored lane identifier uniquely configured to identify the lane in the storage area of the distributed storage system. The metadata index 734 further includes a metadata-stored random number unique to the lane.

The operation then continues to determine whether the lane identified by the metadata-stored lane identifier 122 is an active lane or unused storage that may be available to be configured as a lane. Accordingly, the distributed storage system reads the lane-stored lane header 715.1 as designated (e.g., pointed to) by the metadata-stored lane identifier 122. The lane-stored lane header 715.1 includes a lane-stored lane identifier 722, a lane-stored random number 723, and a lane-stored lane magic value 714.

In order to verify the active status of the identified lane, the distributed storage system generates a metadata-generated lane magic value 755 based on, for example, an exclusive-OR-ing operation 762 of the metadata-stored lane identifier 122, and the metadata-stored random number 123 in the metadata index 734. In response to the metadata-generated lane magic value 755 matching the lane-stored lane magic value 714, the lane in the storage area of the distributed storage system is identified in a step 750.1 as an “active” lane in the distributed storage system. If the metadata-generated lane magic value 755 does not match the lane-stored lane magic value 714, then the storage area is available for creating a new lane in response to the storage area either never having been previously used for storing data, or the lane-stored random number 723 could have been overwritten by a different number resulting in the effective erasure of the entire lane. In some instances, the lane-stored random number may be changed to effectively erase the storage area of the lane in the distributed storage system.

The operations may then continue to identify segments in the storage area to verify if they are known or accessible through the metadata index. In response to the lane 710.1 in the storage area being an active lane, the distributed storage system may read a metadata first segment index number 724.1 from the metadata index 734 and read a lane-stored first segment header 725.1 as designated (e.g., pointed to) by the metadata first segment index number 724.1, of a first segment 710.1 in the storage area 720.1 of the active lane 710.1 of the distributed storage system. The lane-stored first segment header 725.1 includes a lane-stored first segment index number 729.1 configured to uniquely identify the first segment 710.1, and a lane-stored first segment magic value 774.1.1. The lane-stored segment magic value 774.1.1 was generated by, for example, exclusive-OR-ing the lane-stored first segment index number 729.1 with the lane-stored random number 723.

The distributed storage system then generates a metadata-generated first segment magic value 771 based on, for example, an exclusive-OR-ing operation 772 of the metadata-stored first segment index number 724.1, and the metadata-stored random number 123 in the metadata index 734. In response to the metadata-generated first segment magic value 771 matching the lane-stored first segment magic value 774.1.1, the distributed storage system identifies the first segment 710.1 in the storage area 720.1 as an active storage first segment 720.1 in the active lane 710.1 of the distributed storage system. Further, the operations may continue with any subsequent segments illustrated as second segment 710.2 and third segments 710.3.

Subsequent segments 710 in a corresponding storage area may be determined when there are no corresponding entries in the metadata index 734. For example, the distributed storage system may generate a sequentially-generated second segment index number that is sequentially next following the lane-stored first segment index number. The distributed storage system may read a lane-stored second segment header 725.2 which is designated (e.g., pointed to) by the sequentially-generated second index number 729.2 of a subsequent or second segment 710.2 in the storage area 720.1 of the active lane 710.1 of the distributed storage system. The lane-stored second segment header may include a lane-stored second segment index number 729.2 configured to uniquely identify a second segment 710.2, and a lane-stored second segment magic value 774.2.1.

The distributed storage system may generate a sequentially-generated second segment magic value 773 based on the sequentially-generated second segment index number 729.2, and the metadata-stored random number 123 in the metadata index 734. In response to the sequentially-generated second segment magic value 773 matching the lane-stored second segment magic value 774.2.1, the distributed storage system identifies the second segment 710.2 in the storage area 720.1 as a second active storage second segment in the active lane 710.1 of the distributed storage system.

Further, in response to the sequentially-generated second segment index number 729.2 being absent from the metadata index 734, the distributed storage system may write the sequentially-generated second segment index number 724.2, and any further generated accompanying offset 726.2 into the metadata index 734. The operations may continue for subsequent segments such as third segment index number 724.3, and any further generated accompanying offset 726.3.

The operations may further include segment magic values in footers of the segments. For example, the first segment 710.1 may further include a first footer 785.1 including a first footer segment magic value 774.1.2 configured to match, or be related to, the lane-stored lane magic value 774.1.1.

In further operations, the lane may be a valid lane but the above processing may indicate the segments are invalid. Such a determination results in the identification of an effective write pointer identifying the next available storage area for storing object data. For example, in response to identifying the lane in the storage area as an active lane, the distributed storage system reads a lane-stored first segment header 725.4 of a first segment in the storage area 720.1 of the active lane 710.1 of the distributed storage system. The lane-stored first segment header 725.4 includes a lane-stored first segment index number 729.4 configured to uniquely identify the first segment 710.4, and a lane-stored first segment magic value 774.4.

The distributed storage system generates a lane-generated first segment magic value 777 based on, for example, an exclusive-OR-ing operation 776, the lane-stored first segment index number 729.4, which may be a subsequently generated segment index number based on a previous valid segment, and the lane-stored random number 723 in the lane-stored lane header 715.1. In response to the lane-generated first segment magic value 777 not matching the lane-stored first segment magic value 774.4.1, the distributed storage system identifies the first segment 710.4 in the storage area as an available storage first segment in the active lane of the distributed storage system. Accordingly, the above process effectively creates a write pointer without requiring the writing and continuous rewriting of a value to storage devices that are capable of a limited number of reliable rewrite cycles for each of the storage cells before the performance of the storage cells degrades.

FIG. 8 illustrates a method 800 for verifying and correcting metadata indexes as well as identifying actual stored data objects in the presence of random stored values that are remnants of deleted data objects in a distributed storage system.

In a block 810, a distributed storage system requests a metadata index from non-volatile storage in a distributed storage system, where the metadata index includes a metadata-stored lane identifier uniquely configured to identify the lane in the storage area of the distributed storage system, and a metadata-stored random number unique to the lane.

In a block 820, the distributed storage system reads a lane-stored lane header in the storage area of the distributed storage system, where the lane-stored lane header includes a lane-stored lane identifier, a lane-stored random number, and a lane-stored lane magic value.

In a block 830, the distributed storage system generates a metadata-generated lane magic value based on the metadata-stored lane identifier, and the metadata-stored random number in the metadata index.

In block 840, the distributed storage system, in response to the metadata-generated lane magic value matching the lane-stored lane magic value, identifies the lane in the storage area of the distributed storage system as an active lane in the distributed storage system.

FIG. 9 is a diagram of a distributed storage system configured to verify and correct metadata indexes as well as to identify actual stored data objects in the presence of random stored values that are remnants of deleted data objects. The ability for a large-scale distributed object storage system to efficiently and reliably handle read and write operations in a scalable way depends on an efficient and robust handling of a metadata index which can tolerate system failures without compromising efficiency. Known approaches for increasing robustness against system failures introduce drawbacks of efficiency and responsiveness. In order to solve this problem, there is made use of the trusted magic concept described herein which provides robustness against the (partial) loss/lack of the metadata index in RAM, for example during startup, after a system failure, etc.

The distributed storage system 900 may include a bus 910 interconnecting at least one communication unit 912, at least one processor 914, and at least one memory 916. Bus 910 may include one or more conductors that permit communication among the components of the distributed storage system 900. Communication unit 912 may include any transceiver-like mechanism that enables distributed storage system 900 to communicate with other devices and/or systems. For example, communication unit 912 may include wired or wireless mechanisms for communicating with the client device 106 via a network 140.

Processor 914 may include any type of processor or microprocessor that interprets and executes instructions. Memory 916 may include a random access memory (RAM) or another type of dynamic storage device that stores information and instructions for execution by processor 914 and/or a read-only memory (ROM) or another type of static storage device that stores static information and instructions for use by processor 914 and/or any suitable storage element such as a hard disk or a solid-state storage element.

Distributed storage system 900 may include or have access to one or more databases 960 which may include one or more data structures or records for non-volatilely storing data objects 116 and a copy of the metadata index 734.

Distributed storage system 900 may include a plurality of modules or subsystems that are stored and/or instantiated in memory 916 for execution by processor 914. For example, memory 916 may include a means for requesting a metadata index from non-volatile storage in a distributed storage system, the metadata index including a metadata-stored lane identifier uniquely configured to identify the lane in the storage area of the distributed storage system, and a metadata-stored random number unique to the lane.

Also, the memory 916 may include a means for reading a lane-stored lane header, designated (e.g., pointed to) by the metadata-stored lane identifier, in the storage area of the distributed storage system, the lane-stored lane header including a lane-stored lane identifier, a lane-stored random number, and a lane-stored lane magic value. Further, the memory 916 may include a means for generating a metadata-generated lane magic value based on the metadata-stored lane identifier, and the metadata-stored random number in the metadata index. Yet further, the memory 916 may include in response to the metadata-generated lane magic value matching the lane-stored lane magic value, means for identifying the lane in the storage area of the distributed storage system as an active lane in the distributed storage system.

More specifically, a request processing module 920 may be configured to request a metadata index from non-volatile storage in a distributed storage system, the metadata index including a metadata-stored lane identifier uniquely configured to identify the lane in the storage area of the distributed storage system, and a metadata-stored random number unique to the lane.

A metadata index processing module 930 may be configured to read a lane-stored lane header, designated (e.g., pointed to) by the metadata-stored lane identifier, in the storage area of the distributed storage system, the lane-stored lane header including a lane-stored lane identifier, a lane-stored random number, and a lane-stored lane magic value. The metadata index processing module 930 may also be configured to generate a metadata-generated lane magic value based on the metadata-stored lane identifier and the metadata-stored random number in the metadata index. Yet further, the metadata index processing module 930 may be configured to, in response to the metadata-generated lane magic value matching the lane-stored lane magic value, identify the lane in the storage area of the distributed storage system as an active lane in the distributed storage system.

In other embodiments, the metadata index processing module 930 may be further configured to, in response to identifying the lane in the storage area as an active lane, read a lane-stored first segment header, designated (e.g., pointed to) by the metadata first segment index number, of a first segment in the storage area of the active lane of the distributed storage system. The lane-stored first segment header includes a lane-stored first segment index number configured to uniquely identify the first segment and a lane-stored first segment magic value.

Further, the metadata index processing module 930 is configured to generate a metadata-generated first segment magic value based on the metadata first segment index number and the metadata random number in the metadata index. Yet further, the metadata index processing module 930 is further configured, in response to the metadata-generated first segment magic value matching the lane-stored first segment magic value, identify the first segment in the storage area as an active storage first segment in the active lane of the distributed storage system.

In other embodiments, the metadata index processing module 930 is configured to generate the metadata-generated lane magic value by exclusive-OR-ing the metadata-stored lane identifier with the metadata-stored random number.

In still other embodiments, the metadata index processing module 930, in response to the metadata-generated first segment magic value matching the lane-stored first segment magic value, is configured to generate a sequentially-generated second segment index number that is sequentially next following the lane-stored first segment index number; read a lane-stored second segment header, designated (e.g., pointed to) by the sequentially-generated second index number, of a second segment in the storage area of the active lane of the distributed storage system, the lane-stored second segment header including a lane-stored second segment index number configured to uniquely identify a second segment, and a lane-stored second segment magic value; generate a sequentially-generated second segment magic value based on the sequentially-generated second segment index number, and the metadata-stored random number in the metadata index; and in response to the sequentially-generated second segment magic value matching the lane-stored second segment magic value, identify the second segment in the storage area as a second active storage second segment in the active lane of the distributed storage system; and in response to the sequentially-generated second segment index number being absent from the metadata index, write the sequentially-generated second segment index number to the metadata index.

While at least one exemplary embodiment has been presented in the foregoing detailed description of the technology, it should be appreciated that a number of variations may exist. It should also be appreciated that an exemplary embodiment or exemplary embodiments are examples, and are not intended to limit the scope, applicability, or configuration of the technology in any way. Rather, the foregoing detailed description will provide those skilled in the art with a convenient road map for implementing an exemplary embodiment of the technology, it being understood that various modifications may be made in a function and/or arrangement of elements described in an exemplary embodiment without departing from the scope of the technology, as set forth in the appended claims and their legal equivalents.

As will be appreciated by one of ordinary skill in the art, various aspects of the present technology may be embodied as a system, method, or computer program product. Accordingly, some aspects of the present technology may take the form of a hardware embodiment, a software embodiment (including firmware, resident software, micro-code, etc.), or a combination of hardware and software aspects that may all generally be referred to herein as a circuit, module, system, and/or network. Furthermore, various aspects of the present technology may take the form of a computer program product embodied in one or more computer-readable mediums including computer-readable program code embodied thereon.

Any combination of one or more computer-readable mediums may be utilized. A computer-readable medium may be a computer-readable signal medium or a physical computer-readable storage medium. A physical computer-readable storage medium may be, for example, but not limited to, an electronic, magnetic, optical, crystal, polymer, electromagnetic, infrared, or semiconductor system, apparatus, or device, etc., or any suitable combination of the foregoing. Non-limiting examples of a physical computer-readable storage medium may include, but are not limited to, an electrical connection including one or more wires, a portable computer diskette, a hard disk, RAM, read-only memory (ROM), an erasable programmable read-only memory (EPROM), an electrically erasable programmable read-only memory (EEPROM), a Flash memory, an optical fiber, a compact disk read-only memory (CD-ROM), an optical processor, a magnetic processor, etc., or any suitable combination of the foregoing. In the context of this document, a computer-readable storage medium may be any tangible medium that can contain or store a program or data for use by or in connection with an instruction execution system, apparatus, and/or device.

Computer code embodied on a computer-readable medium may be transmitted using any appropriate medium, including but not limited to, wireless, wired, optical fiber cable, radio frequency (RF), etc., or any suitable combination of the foregoing. Computer code for carrying out operations for aspects of the present technology may be written in any suitable programming language. The computer code may execute on a user's computing device, partly on a user's computing device, as a stand-alone software package, partly on a user's computing device and partly on a remote computing device, or on the remote computing device or a server. In the latter scenario, a remote computing device may be connected to a user's computing device through any type of network, or communication system, including, but not limited to, a local area network (LAN) or a wide area network (WAN), Converged Network, or the connection may be made to an external computer (e.g., through the Internet using an Internet Service Provider).

Various aspects of the present technology may be described above with reference to flowchart illustrations and/or block diagrams of methods, apparatus, systems, and computer program products. It will be understood that each block of a flowchart illustration and/or a block diagram, and combinations of blocks in a flowchart illustration and/or block diagram, is implemented by computer program instructions. These computer program instructions may be provided to a processing device (processor) of a general-purpose computer, special purpose computer, or other programmable data processing apparatus to produce a machine, such that the instructions, which can execute via the processing device or other programmable data processing apparatus, create means for implementing the operations/acts specified in a flowchart and/or block(s) of a block diagram.

Some computer program instructions may also be stored in a computer-readable medium that can direct a computer, other programmable data processing apparatus, or other device(s) to operate in a particular manner, such that the instructions stored in a computer-readable medium to produce an article of manufacture including instructions that implement the operation/act specified in a flowchart and/or block(s) of a block diagram. Some computer program instructions may also be loaded onto a computing device, other programmable data processing apparatus, or other device(s) to cause a series of operational steps to be performed on the computing device, other programmable apparatus or other device(s) to produce a computer-implemented process such that the instructions executed by the computer or other programmable apparatus provide one or more processes for implementing the operation(s)/act(s) specified in a flowchart and/or block(s) of a block diagram.

A flowchart and/or block diagram in the above figures may illustrate an architecture, functionality, and/or operation of possible implementations of apparatus, systems, methods, and/or computer program products according to various aspects of the present technology. In this regard, a block in a flowchart or block diagram may represent a module, segment, or portion of code, which may comprise one or more executable instructions for implementing one or more specified logical functions. It should also be noted that, in some alternative aspects, some functions noted in a block may occur out of an order noted in the figures. For example, two blocks shown in succession may, in fact, be executed substantially concurrently, or blocks may at times be executed in a reverse order, depending upon the operations involved. It will also be noted that a block of a block diagram and/or flowchart illustration or a combination of blocks in a block diagram and/or flowchart illustration, is implemented by special purpose hardware-based systems that may perform one or more specified operations or acts, or combinations of special purpose hardware and computer instructions.

While one or more aspects of the present technology have been illustrated and discussed in detail, one of ordinary skill in the art will appreciate that modifications and/or adaptations to the various aspects may be made without departing from the scope of the present technology, as set forth in the following claims.

1. A method, comprising:
requesting a metadata index from non-volatile storage in a distributed storage system,
wherein the metadata index includes:
a metadata-stored lane identifier uniquely configured to identify a lane in a storage area of the distributed storage system; and
a metadata-stored random number unique to the lane;
reading a lane-stored lane header in the storage area of the distributed storage system pointed to by the metadata-stored lane identifier, wherein the lane-stored lane header includes:
a lane-stored lane identifier;
a lane-stored random number; and
a lane-stored lane magic value;
generating, in the metadata index, the metadata-stored random number and a metadata-generated lane magic value based on the metadata-stored lane identifier; and
in response to the metadata-generated lane magic value matching the lane-stored lane magic value, identifying the lane in the storage area of the distributed storage system as an active lane in the distributed storage system.

2. The method of claim 1, wherein generating the metadata-generated lane magic value includes exclusive OR-ing the metadata-stored lane identifier with the metadata-stored random number.

3. The method of claim 1, further comprising:
in response to identifying the lane in the storage area as an active lane:
reading a metadata first segment index number from the metadata index;
reading a lane-stored first segment header, designated by the metadata first segment index number, of a first segment in the storage area of the active lane of the distributed storage system, wherein the lane-stored first segment header includes a lane-stored first segment magic value and a lane-stored first segment index number configured to uniquely identify the first segment;
generating, in the metadata index, the metadata-stored random number and a metadata-generated first segment magic value based on the metadata first segment index number; and
in response to the metadata-generated first segment magic value matching the lane-stored first segment magic value, identifying the first segment in the storage area as an active storage first segment in the active lane of the distributed storage system.

4. The method of claim 3, wherein matching the lane-stored first segment magic value further comprises:
generating a sequentially-generated second segment index number that is sequentially next following the lane-stored first segment index number;
reading a lane-stored second segment header, designated by the sequentially-generated second segment index number, of a second segment in the storage area of the active lane of the distributed storage system, wherein the lane-stored second segment header includes a lane-stored second segment magic value and a lane-stored second segment index number configured to uniquely identify the second segment; and
generating, in the metadata index, the metadata-stored random number and a sequentially-generated second segment magic value based on the sequentially-generated second segment index number.

5. The method of claim 4, wherein matching the lane-stored first segment magic value further comprises, in response to the sequentially-generated second segment magic value matching the lane-stored second segment magic value, identifying the second segment in the storage area as a second active storage second segment in the active lane of the distributed storage system.

6. The method of claim 4, wherein matching the lane-stored first segment magic value further comprises, in response to the sequentially-generated second segment index number being absent from the metadata index, writing the sequentially-generated second segment index number to the metadata index.

7. The method of claim 3, wherein the first segment further comprises a first footer that includes a first footer segment magic value configured to match the lane-stored lane magic value.

8. The method of claim 1, further comprising:
in response to identifying the lane in the storage area as an active lane:
reading a lane-stored first segment header of a first segment in the storage area of the active lane of the distributed storage system, wherein the lane-stored first segment header includes a lane-stored first segment magic value and a lane-stored first segment index number configured to uniquely identify the first segment;
generating a lane-generated first segment magic value based on the lane-stored first segment index number and the lane-stored random number in the lane-stored lane header; and
in response to the lane-generated first segment magic value not matching the lane-stored first segment magic value, identifying the first segment in the storage area as an available storage first segment in the active lane of the distributed storage system.

9. The method of claim 1, further comprising changing the lane-stored random number to effectively erase the storage area of the lane in the distributed storage system.

10. The method of claim 1, wherein requesting the metadata index further comprising:
retrieving a non-volatilely stored metadata index from the non-volatile storage; and
generating the metadata index in volatile storage.

11. A system, comprising:
a request processing module configured to:
request a metadata index from non-volatile storage in a distributed storage system,
wherein the metadata index includes:
a metadata-stored lane identifier uniquely configured to identify a lane in a storage area of the distributed storage system; and
a metadata-stored random number unique to the lane; and
a metadata index processing module configured to:
read a lane-stored lane header in the storage area of the distributed storage system pointed to by the metadata-stored lane identifier, wherein the lane-stored lane header includes:
a lane-stored lane identifier;
a lane-stored random number; and
a lane-stored lane magic value;
generate, in the metadata index, the metadata-stored random number and a metadata-generated lane magic value based on the metadata-stored lane identifier; and
in response to the metadata-generated lane magic value matching the lane-stored lane magic value, identify the lane in the storage area of the distributed storage system as an active lane in the distributed storage system.

12. The system of claim 11, wherein to generate the metadata-generated lane magic value includes to exclusive OR the metadata-stored lane identifier with the metadata-stored random number.

13. The system of claim 11, wherein the metadata index processing module is further configured to:
in response to identifying the lane in the storage area as an active lane:
read a lane-stored first segment header, designated by a metadata-stored first segment index number, of a first segment in the storage area of the active lane of the distributed storage system, wherein the lane-stored first segment header includes a lane-stored first segment magic value and a lane-stored first segment index number configured to uniquely identify the first segment;
generate, in the metadata index, a metadata-generated first segment magic value based on the metadata-stored first segment index number and the metadata-stored random number; and
in response to the metadata-generated first segment magic value matching the lane-stored first segment magic value, identify the first segment in the storage area as an active storage first segment in the active lane of the distributed storage system.

14. The system of claim 13, wherein the metadata index processing module is further configured to:
generate a sequentially-generated second segment index number that is sequentially next following the lane-stored first segment index number;
read a lane-stored second segment header, designated by the sequentially-generated second segment index number, of a second segment in the storage area of the active lane of the distributed storage system, wherein the lane-stored second segment header includes a lane-stored second segment magic value and a lane-stored second segment index number configured to uniquely identify the second segment; and
generate, in the metadata index, the metadata-stored random number and a sequentially-generated second segment magic value based on the sequentially-generated second segment index number.

15. The system of claim 14, wherein the metadata index processing module is further configured to, in response to the sequentially-generated second segment magic value matching the lane-stored second segment magic value, identify the second segment in the storage area as a second active storage second segment in the active lane of the distributed storage system.

16. The system of claim 14, wherein the metadata index processing module is further configured to, in response to the sequentially-generated second segment index number being absent from the metadata index, write the sequentially-generated second segment index number to the metadata index.

17. The system of claim 13, wherein the first segment further comprises a first footer that includes a first footer segment magic value configured to match the lane-stored lane magic value.

18. The system of claim 11, wherein the metadata index processing module is further configured to:
in response to identifying the lane in the storage area as an active lane:
read a lane-stored first segment header of a first segment in the storage area of the active lane of the distributed storage system, wherein the lane-stored first segment header includes a lane-stored first segment magic value and a lane-stored first segment index number configured to uniquely identify the first segment;
generate a lane-generated first segment magic value based on the lane-stored first segment index number and the lane-stored random number in the lane-stored lane header; and
in response to the lane-generated first segment magic value not matching the lane-stored first segment magic value, identify the first segment in the storage area as an available storage first segment in the active lane of the distributed storage system.

19. The system of claim 11, wherein the metadata index processing module is further configured to change the lane-stored random number to effectively erase the storage area of the lane in the distributed storage system.

20. A system, comprising:
means for requesting a metadata index from non-volatile storage in a distributed storage system, wherein the metadata index includes a metadata-stored lane identifier uniquely configured to identify a lane in a storage area of the distributed storage system and a metadata-stored random number unique to the lane;
means for reading a lane-stored lane header in the storage area of the distributed storage system pointed to by the metadata-stored lane identifier, wherein the lane-stored lane header includes a lane-stored lane identifier, a lane-stored random number, and a lane-stored lane magic value;
means for generating, in the metadata index, the metadata-stored random number and a metadata-generated lane magic value based on the metadata-stored lane identifier; and
means for identifying, in response to the metadata-generated lane magic value matching the lane-stored lane magic value, the lane in the storage area of the distributed storage system as an active lane in the distributed storage system.
